(19) United States
(12) Patent Application Publication
(10) Pub. No.: US 2004/0253452 A1
(43) Pub. Date: Dec. 16, 2004

(54) Method for coating

(76) Inventor: Shinichi Ogino, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/808,507

(22) Filed: Mar. 25, 2004

(30) Foreign Application Priority Data
Mar. 25, 2003 (JP) 2003-82027
Jun. 4, 2003 (JP) 2003-159205

(51) Int. Cl. B05D 3/00; B32B 9/04; B01D 61/58; B01D 57/02; C25B 15/00

(52) U.S. Cl. 428/411.1; 427/541; 427/553; 204/478; 204/484; 204/486

(57) ABSTRACT

According to the present invention, it is possible to save a predrying time and form a uniform film, because water having a high dielectric constant is heated selectively upon predrying of a waterborne coating with microwaves. Particularly when the surface to be coated is plastic, the above-described effect can be exhibited fully. In the method of forming a multilayer film by using a waterborne coating, use of microwaves makes it possible to prevent mixing of plural layers because they are adequately predried, to suppress the total drying time while maintaining good finished appearance and evenness of the coated surface and to attain saving of equipment and energy.

### TECHNICAL FIELD OF THE INVENTION

The present invention relates to a method of forming a uniform film by using a waterborne coating and drying with microwaves; and an article having the film formed thereon by this method.

### DISCRIPTION OF RELATED ART

In recent years, the paint industry has proceeded with transition of coatings from solventborne to waterborne in consideration of environmental problems. In general, ordinary employed thermosetting waterborne coatings are heated and dried by maintaining the coating at a temperature of from 80 to 150° C. for a long time in a hot air drying apparatus, exposing to infrared rays or the like.

Upon application, however, waterborne coatings require countermeasures such as speed down of a coating line for keeping sufficient drying time, elongation of a line length, increase in the feed amount of hot air or exposure amount to infrared rays, because waterborne coatings cannot be dried speedily owing to latent heat of evaporation greater in water than in organic solvents.

When applied to the surface of a substrate such as plastic, drying in a hot air drying apparatus happens to cause deformation of the substrate by heat so that drying conditions must be controlled, for example, by lowering the temperature or extending the drying time.

Exposure to high frequency waves as high as 300 MHz to 300 GHz, which are called microwaves, has been used widely for heating or drying of materials. Microwaves are considered particularly useful for drying of waterborne coatings, because water has a large dielectric constant and use of exposure to microwaves for drying of waterborne coatings is known (Non-patent Document 1, etc.).

See pages 481-495 of Summary Collection of International Waterborne, High-Solids, and Powder Coatings Symposlum.

### SUMMARY OF THE INVENTION

In general, the calorific value added by exposure to microwaves is proportion to a dielectric loss coefficient of a material to be exposed and the dielectric loss coefficient tends to decrease with an increase in the temperature of the material to be exposed. Accordingly, when a coating film formed by a waterborne coating is exposed to microwaves, as the temperature of the film rises, a reduction in the dielectric loss coefficient of the film and lowering in the water content in the film occur, leading to the phenomenon of lowering in the calorific amount. A calorific amount necessary for drying and curing of the coating film cannot be fully supplied only by exposure to microwaves. Particularly, in coatings which cure at high temperatures (for example, 120° C. or greater), curing reaction does not proceed smoothly by exposure to microwaves.

An object of the present invention is to carry out sufficient predrying to prevent mixing of layers, shorten the total drying time while maintaining good finished appearance or evenness of the coated surface and attain saving of equipment and energy by using a method of drying a waterborne coating by exposure to microwaves and forming a uniform coating film, particularly a method of applying the predrying by exposure to microwaves to a step of forming a multilayer film containing a waterborne coating.

The present invention relates to a coating film forming method comprising applying a waterborne coating to the surface of a substrate and then drying to form a coating film, the improvement wherein the wet coating is exposed to microwaves for predrying.

The wet coating may be exposed to microwaves at an output power of from 20W to 20 KW for from 10 seconds to 600 seconds.

The solid content of the wet coating may be controlled to 80% or greater by exposure to microwaves.

The surface of a substrate may be plastic.

The plastic may be a thermal softening point of 100° C. or less.

In a film froming method of the present invention, a waterborne coating maybe a waterborne primer coating or electrodeposition coating; and after application of the waterborne primer coating or electrodeposition coating to the surface of a substrate, the wet coating is predried by exposure to microwaves, followed by application of a top coat.

The waterborne coating is a waterborne primer coating or electrodeposition coating, and after application of the waterborne primer coating or electrodeposition coating to the surface of a substrate, the wet coating is predried by exposure to microwaves, followed by application of an intermediate coating.

The waterborne coating may be a waterborne primer coating or waterborne intermediate coating, and after application of the waterborne primer coating or waterborne intermediate coating to the surface of a substrate, the wet coating is predried by exposure to microwaves, followed by application of a top coat.

The waterborne coating maybe a thermosetting waterborne top coat containing a coloring pigment and/or light reflecting pigment, and after application of the thermosetting waterborne top coat to the surface of a substrate, the wet coating is predried by exposure to microwaves, a thermosetting clear coating is applied, and then the both wet coatings are dried simultaneously by heating.

After application of a first thermosetting waterborne top coat containing the coloring pigment and/or light reflecting pigment to the surface of a substrate and predrying of the wet coating by exposure to microwaves, a second thermosetting waterborne top coat containing a coloring pigment and/or light reflecting pigment may be applied, and then the wet coating may be predried by exposure to microwaves, a thermosetting clear coating may be applied, and further the three wet coatings may be then cured simultaneously by heating and drying.

### DETAILED DISCRIPTION OF THE INVENTION

Examples of microwave irradiator used in the present invention include batch oven, conveyer oven and mobile oven. A proper one is selected, depending on the quality, shape or size of a portion to be heated. Any irradiator capable of exposing the heated portion to microwaves can be used without being limited by the shape of the irradiator. If necessary, hot air feeding or exposure to infrared rays may be used in combination, or a batch oven may be used under reduced pressure.

Examples of the surface of a substrate used in the present invention include a concrete face, a mortar face, a slate board, a PC board, an AL board, a cement calcium silicate board, a concrete block face, and substrates such as wood, stone, plastic and metal. These substrates subjected to anticorrosive treatment or coating treatment can also be used as the surface of a substrate.

In general, the surface of a substrate preferably has a dielectric constant lower than that of a waterborne coating. If the surface of a substrate has such a dielectric constant, not the surface but the wet coating is selectively heated, making it possible to effectively predry it.

Examples of such a surface of a substrate include plastic. Plastic having a thermal softening point of 100° C. or less is particularly suited to the invention method. The term “thermal softening point” as used herein means a temperature at which plastic starts softening and can be deformed.

Any conventionally known waterborne coating can be used in the present invention without limitation insofar as it uses, as a medium, water or a water-organic solvent mixed solution composed mainly of water and obtained by dissolving an organic solvent such as water-soluble organic solvent in water. Examples include air drying or heat curable coatings such as waterborne primer coating, waterborne intermediate coating, electrodeposition coating, and waterborne top coat.

The term “primer coating” usually means a coating directly applied to the surface of a substrate because of improvement in adhesion; the term “electrodeposition coating” usually means a coating applied by electrodeposition; the term “intermediate coating” means a coating applied between undercoating such as primer coating or electrodeposition coating and top coat; and the term “top coat” means, among the coating system, a coating applied to an upper layer (for example, over an under coat or over an intermediate coating).

Examples of the waterborne primer coatings include waterborne coatings which use one or more resins selected from polyurethane resin, polyester resin, epoxy resin, acrylic resin, fluorine resin, polyvinyl chloride resin and a resin containing a polymerizable unsaturated group, and a modified resin thereof, and are obtained by incorporating in the resin a neutralizer, pigment, hydrophilic solvent, curing agent and/or additive as needed and then formulating the mixture in a conventional manner.

The electrodeposition coatings include cationic waterborne coatings using a basic water dispersible resin to be neutralized with an organic or inorganic acid, or a resin such as epoxy resin, acrylic resin or a polybutadiene resin having, in the skeleton thereof, many amino groups; and anionic waterborne coatings using an acidic water dispersible resin to be neutralized with an organic or inorganic base, or a resin such as epoxy resin, acrylic resin or a polybutadiene resin having, in the skeleton thereof, many carboxyl groups. These electrodeposition coatings are available by adding to the above-described resin a neutralizer, pigment (coloring pigment, extender pigment, rust inhibitive pigment, etc.), hydrophilic solvent, water, curing agent and/or additive as needed and formulating the mixture in a conventional manner.

Examples of the waterborne intermediate coating include waterborne coatings having, as a main vehicle component, a short-oil or ultra short-oil alkyd resin having an oil length of 30% or less, or waterborne coatings having, as a main component, an oil-free polyester resin and an amino resin serving as a crosslinking agent. These waterborne intermediate coatings are available by adding, to the resin, a neutralizer, pigment, hydrophilic solvent, curing agent and/or additive as needed and formulating the mixture in a conventional manner. As the amino resin, a (C₁₋₅) alkyl-etherified melamine resin, urea resin or benzoguanamine resin is suited. The amino resin may be substituted by a polyisocyanate compound or a block polyisocyanate compound.

Examples of the waterborne top coat include thermosetting waterborne top coats containing a coloring pigment and/or light reflecting pigment. Their main solvent is water and they contain a water soluble or water dispersible thermosetting resin. Examples of the water soluble or water dispersible thermosetting resin include acrylic resins, polyester resins, polyurethane resins, block-isocyanate-containing polyester resins and modified resins thereof. Acrylic resins or polyester resins having an acid value of from 20 to 100 mg KOH/g and a hydroxyl value of from 20 to 200 mg KOH/g are particularly suited. The waterborne top coat is available by adding, to the resin, a neutralizer, hydrophilic solvent, water, curing agent and/or additive as needed and then formulating the mixture into the top coat in a conventional manner.

Examples of coloring pigments include white pigments such as titanium oxide, zinc oxide, basic lead carbonate, basic lead sulfate, lead sulfate, lithopone, zinc sulfide, and antimony white; black pigments such as carbon black, acetylene black, lamp black, bone black, graphite, iron black, and aniline black; yellow pigments such as naphthol yellow S, Hansa yellow, pigment yellow L, benzidine yellow, and permanent yellow; orange pigments such as chrome orange, chrome vermilion and permanent orange; brown pigments such as iron oxide and amber; red pigments such as red iron oxide, red lead oxide, permanent red and quinacridone red pigments; violet pigments such as cobalt violet, fast violet and methyl violet lake; blue pigments such as ultramarine blue, Prussian blue, cobalt blue, phthalocyanine blue and indigo; and green pigments such as chrome green, pigment green B and phthalocyanine green.

Examples of the light reflecting pigment include aluminum powder, bronze powder, copper powder, tin powder, lead powder, zinc powder, iron phosphide, pearl-like metal coated mica powder and iron oxide in the mica form.

The invention method comprises applying the waterborne coating and predrying the wet coating by exposure to microwaves.

The waterborne coating can be applied in a conventional manner such as spray coating, roller coating or electrodeposition coating. The application is conducted to give a coating film thickness of from 100 μm or less, preferably within a range of from 5 μm to 100 μm in terms of the thickness after drying/curing.

As predrying conditions in the present invention, it is preferred to expose the wet coating to microwaves at an output power of from 20W to 20 KW for 10 seconds to 600 seconds. Exposure under the above-described conditions can suppress a temperature rise of the substrate and brings about effects for selectively heating and evaporating the water content in the waterborne coating applied to the substrate.

It is preferred to control the solid content of the wet coating, which has been obtained by applying the waterborne coating, to 80% or greater, more preferably 85% or greater, after predrying. The solid content less than 80% is not preferred, because layers are mixed upon formation of a multilayer film or popping deteriorates the finished appearance. The solid content of the wet coating in the present invention is calculated in the following manner: with a scraped film as a sample, the sample is air dried at 25° C. until it has a constant weight and the solid content is calculated from a difference in the weight just after application and constant weight.

In the present invention, after the wet coating is exposed to microwaves for predrying, it may be dried and cured by using any one of or combination of air drying, forced drying, heating and drying, exposure to ultraviolet rays and exposure to infrared rays.

In the present invention, there are also provided the below-described coating film forming methods by making use of the above-descried method of predrying the wet coating of the waterborne coating by exposure to microwaves.

(I) A coating film forming method of applying the above-described waterborne primer or electrodeposition coating to the surface of a substrate, predrying the wet coating by exposure to microwaves, and then applying a top coat.

(II) A coating film forming method of applying the waterborne primer or electrodeposition coating to the surface of a substrate, predrying the wet coating by exposure to microwaves, and then applying an intermediate coating; or applying the electrodeposition coating to the surface of a substrate, predrying the wet coating by exposure to microwaves, and then applying the primer coating or the intermediate coating.

(III) A coating film forming method of applying the thermosetting waterborne top coat to the surface of a substrate, predrying the wet coating by exposure to microwaves, applying a thermosetting clear coating, and heating and drying to cure these wet coatings simultaneously.

(IV) A coating film forming method of applying a first thermosetting waterborne top coat containing the coloring pigment and/or light reflecting pigment to the surface of a substrate, followed by predrying of the wet coating by exposure to microwaves; applying a second thermosetting waterborne top coat containing the coloring pigment and/or light reflecting pigment, followed by predrying of the wet coating by exposure to microwaves; and applying a thermosetting clear coating, followed by heating and drying to cure these three wet coatings simultaneously.

(V) A coating film forming method of applying the electrodeposition coating to the surface of a substrate, followed by predrying of the wet coating by exposure to microwaves; applying the waterborne intermediate coating, and predrying the wet coating by exposure to microwaves, followed by heating and drying; applying the thermosetting waterborne top coat, followed by predrying of the wet coating by exposure to microwaves; and applying a thermosetting clear coating, followed by heating and drying.

(VI) A coating film forming method of applying the electrodeposition coating to the surface of a substrate, followed by predrying of the wet coating by exposure to microwaves; applying the waterborne intermediate coating, and predrying the wet coating by exposure to microwaves, followed by heating and drying; applying a thermosetting waterborne top coat containing the coloring pigment, followed by predrying of the wet coating by exposure to microwaves; applying a thermosetting waterborne top coat containing the light reflecting pigment, followed by predrying of the wet coating by exposure to microwaves; and applying a thermosetting clear coating, followed by heating and drying.

In the above-described method (I), either one of waterborne or solventborne top coat can be applied to the wet coating obtained by drying by microwaves. The top coat may be either one of ambient temperature curing type or thermosetting type. Specific examples include top coats which have, as a vehicle component, a resin such as acrylic resin, amino resin, alkyd resin or polyester resin, and have been formulated in a conventional manner after incorporation of a neutralizer, hydrophilic solvent, curing agent, additive and/or pigment as needed.

In the above-described method (II), the intermediate coating to be applied to the wet coating obtained by predrying by microwaves may be either one of waterborne or solventborne coating. The intermediate coating may be either one of ambient temperature curing type or thermosetting type. Waterborne intermediate coatings as described above are particularly suited in the present invention. The drying method of the wet coating of the intermediate coating may be selected as needed, depending on the components of the coating, film thickness or the like. Examples of the drying method include a method comprising predrying by exposure to microwaves, and any one of or combination of air drying, forced drying, heating and drying, exposure to ultraviolet rays and exposure to infrared rays.

In the methods (III), (IV), (V) and (VI), thermosetting clear coatings are waterborne, solventborne or powder thermosetting coatings containing a base resin and a crosslinking agent, and optionally a ultraviolet absorber, and a photostabilizer. They have transparency enough to permit visual recognition of the underlying film through the film of this clear coating. In the present invention, it is preferred to, after predrying the thermosetting waterborne coating containing a coloring pigment and/or light reflecting pigment, apply the thermosetting clear coating to the predried but not cured surface, and then curing these two wet coatings simultaneously by heating and drying, from the viewpoints of improvement of adhesion between these two films and finished appearance. When the thermosetting clear coating is a waterborne coating, it is possible to save drying time by applying the thermosetting clear coating and then predrying the wet coating by exposure to microwaves prior to heating and drying.

In the above-described method (IV), specific examples of a combination of the first thermosetting waterborne top coat and second thermosetting waterborne top coat include that of a thermosetting waterborne top coat containing a coloring pigment as the first thermosetting waterborne coating and a thermosetting waterborne top coat containing a light reflecting pigment as the second thermosetting waterborne coating. After application and predrying of each of the first and second thermosetting waterborne top coats, the thermosetting clear coating is applied, followed by heating and drying to simultaneously cure these three layers. By the above-described manner, a multilayer film having a solid base as a lower layer, a metallic base as an intermediate layer and a clear film as an upper layer can be formed. It is possible to obtain a multilayer metallic film excellent in orientation, denseness and photoluminescence in a short time by the 3 coat 1 bake system without mixing three layers.

### EXAMPLES

In the present invention, the above-described steps as described in from (I) to (IV) can be used in combination. Specific examples include steps as described in (V) and (VI). This makes it possible to save drying time and electric power consumption effectively.

### EXAMPLES

The present invention will hereinafter be described in further detail by Examples. In all the designations, “part” or “parts” and “%” mean “part by weight” or “parts by weight” and “wt. %”, respectively unless otherwise specifically indicated. The thickness of a coating film is that of a cured film.

(1) Waterborne Primer Coating (A-1)

“HARDLEN EH-202” (product of TOYO KASEI KOGYO, maleic-anhydride-modified chlorinated polypropylene aqueous emulsion, solid content: 20%)

(2) Cationic Electrodeposition Coating (A-2)

“ELECRON #9400” (product of KANSAI PAINT, a cationic electrodeposition coating having a polyamide modified epoxy resin as a base resin and containing a block isocyanate curing agent)

(3) Waterborne Intermediate Coating (B)

A waterborne intermediate coating having a solid content of 40%, which has been obtained by mixing and dispersing 100 parts (as a solid content) of a polyester resin (Note 1), 4 parts of dimethylaminoethanol (Note 2), 41 parts of an aliphatic 6-functional block polyisocyanate compound (Note 3), 140 parts of a titanium white pigment (Note 4), and 2 parts of carbon black (Note 5) in 430 parts of deionized water.

(Note 1) Polyester resin: a polyester resin having a number average molecular weight of about 8,000, an acid value of 20 mg KOH/g and a hydroxyl value of 95 mg KOH/g which has been obtained by charging 756 parts of neopentyl glycol, 109 parts of trimethylol propane, 370 parts of hexahydrophthalic acid, 292 parts of adipic acid and 398 parts of isophthalic acid in a reaction vessel and reacting them at 220° C. for 6 hours, adding 45 parts of trimellitic anhydride to the reaction mixture and reacting them at 170° C. for 30 minutes.

(Note 2) Dimethylaminoethanol: product of NIPPON NYUKAZAI “AMINOALCOHOL 2MABS”

(Note 3) Aliphatic hexa-functional block polyisocyanate compound: a compound obtained by reacting a trimer adduct of hexamethylene diisocyanate with methyl ethyl ketoxime.

(Note 4) Titanium white pigment: “TAYCA JR806” (product of TAICA)

(Note 5) Carbon black: “MITSUBISHI CARBON BLACK M-100” (product of MITSUBISHI CHEMICAL)

(4) Thermosetting Waterborne Top Coat

(C-1) Thermosetting Waterborne Top Coat Containing a Coloring Pigment (C-1)

A thermosetting waterborne top coat obtained by mixing and dispersing 140 parts of a neutralized acrylic resin solution (Note 6) having a solid content of 50%, 34 parts of “Cymel 370” (product of MITSUI CYTECH CO., LTD., a 88% water soluble melamine resin solution), 55 parts of titanium white and 2 parts of carbon black in deionized water and adjusting the resulting mixture to have a solid content of 35% and viscosity of 35 sec. (Ford cup #4, 20° C.).

(Note 6) A neutralized acrylic resin solution obtained by adding dimethylaminoethanol, for neutralization, to an acrylic resin solution (solid content: 60%) having an acid value of 40 mg KOH/g, hydroxyl value of 52 mg KOH/g and number average molecular weight of about 10,000 and obtained by polymerizing 30 parts of methyl methacrylate, 23 parts of ethyl acrylate, 30 parts of butyl acrylate, 12 parts of hydroxyethyl methacrylate and 5 parts of acrylic acid; and then, diluting the resulting mixture with isopropyl alcohol into a solid content of 50%.

Light Reflecting-Pigment-Containing Thermosetting Waterborne Top Coat (C-2)

A thermosetting waterborne metallic coating obtained by mixing 100 parts of a neutralized acrylic resin solution (Note 6) having a solid content of 50%, 100 parts of a neutralized polyester resin solution (Note 7) having a solid content of 50%, 500 parts of an acryl emulsion (Note 8) having a solid content of 20%, 38 parts of “Cymel 370” and 25 parts of “Alumi Paste 891K” (product of Toyo Aluminum) and adjusting the resulting mixture to have a solid content of 25% and viscosity of 45 seconds (Ford Cup #4, 20° C.) with deionized water.

(Note 7) The neutralized polyester resin solution obtained by charging 351 parts of neopentyl glycol, 196 parts of trimethylolpropane, 283 parts of phthalic anhydride and 349 parts of adipic acid in a reaction vessel, reacting the mixture at 220° C. for 6 hours, adding 28 parts of trimellitic anhydride to the reaction mixture, reacting them at 170° C. for 30 minutes, adding butyl cellosolve to prepare a polyester resin solution (solid content; 70%) having an acid value of 40 mg KOH/g and number average molecular weight of about 6,000, adding dimethylaminoethanol to neutralize the resulting mixture and then, diluting the neutralized solution with isopropyl alcohol into a solid content of 50%.

(Note 8) The acrylic emulsion having a solid content of 20% was obtained by adding 140 parts of deionized water, 2.5 parts of 30% “Newcol 707SF” (product of Nippon Nyukazai, surfactant) and 1 part of Monomer Mixture A (mixture of 55 parts of methyl methacrylate, 8 parts of styrene, 9 parts of butyl acrylate, 5 parts of hydroxyethyl acrylate, 2 parts of 1,6-hexanediiol diacrylate and 1 part of methacrylic acid); mixing them under stirring in a nitrogen gas air stream; heating the reaction mixture to 60° C.; adding 3 parts of a 3% aqueous solution of ammonium persulfate; after heating to 80° C., charging a monomer emulsion composed of 79 parts of Monomer Mixture A, 2.5 parts of “Newcol 707SF”, 4 parts of a 3% aqueous solution of ammonium persulfate and 50 parts of deionized water in a reaction vessel over 4 hours; aging the reaction mixture for 1 hour; at 80° C., simultaneously adding 20.5 parts of Monomer Mixture B (a mixture of 5 parts of methyl methacrylate, 7 parts of butyl acrylate, 5 parts of 2-ethylhexyl acrylate, 3 parts of methacrylic acid and 0.5 part of “NEWCOL 707SF”) and 4 parts of a 3% aqueous solution of ammonium persulfate dropwise to the reaction vessel over 1.5 hours; aging the reaction mixture for 1 hour; diluting with 30 parts of deionized water; adding deionized water to the filtrate; and adjusting the pH of the mixture to 7.5 with dimethylaminoethanol.

(5) Thermosetting Clear Coating (D)

The thermosetting clear coating obtained by adjusting a mixture of 57 parts of an acrylic resin solution (Note 9), 50 parts of a non-aqueous acrylic resin dispersion (Note 10), 30 parts of “CYMEL 303” (monomeric melamine resin, product of MITSUI CYTEC), 4 parts of a 25% dodecylbenzenesulfonic acid solution and 0.5 parts of “BYK-300” (leveling agent, product of by BYK CHEMIE JAPAN) to viscosity of 30 seconds (FORD CUP #4, 20° C.) and solid content of 55% with “SWASOL #1000” (aromatic hydrocarbon solvent, product of COSMO OIL).

(Note 9) The acrylic resin solution having a hydroxyl value of 120 mg KOH/g, a number average molecular weight of 6000 and a solid content of 70%, obtained by polymerizing 30 parts of styrene, 35 parts of butyl acrylate, 10 parts of 2-ethylhexyl acrylate and 25 parts of hydroxyethyl acrylate.

(Note 10) The non-aqueous acrylic resin dispersion having a solid content of 60% and varnish viscosity A (Gardner bubble viscosity), obtained by charging 58 parts of “U-VAN 28-60” (60% melamine resin solution, product of MITSUE CHEMICALS), 30 parts of n-heptane and 0.15 part of benzoyl peroxide in a reaction vessel; after heating to 95° C., adding dropwise a mixture of 15 parts of styrene, 9 parts of acrylonitrile, 13 parts of methyl methacrylate, 15 parts of methyl acrylate, 1.8 parts of butyl acrylate, 10 parts of hydroxyethyl methacrylate, 1.2 parts of acrylic acid, 0.5 part of benzoyl peroxide, 5 parts of n-butanol, 30 parts of “SHELLSOL 140” (product of SHELL CHEMICALS) and 9 parts of n-heptane over 3 hours; after 1 hour maturing, adding 0.65 part of t-butyl peroctoate and 3.5 parts of “SHELLSOL 140” dropwise over 1 hour; and after continuous stirring for 2 hours at a temperature adjusted to 95° C., removing the solvent under reduced pressure.

Preparation of Coated Plate

The frequency of microwaves employed in the below-described Examples is 2.45 GHz without exception.

### Example 1

A waterborne primer coating (A-1) was applied to a washed and degreased polypropylene plastic plate (20 cm long, 15 cm wide, 0.5 cm thick, thermal softening point: 80° C.) by spray to give a dry thickness of 7 μm, followed by predrying by exposure to microwaves at an output power of 300W for 2 minutes. The wet coating (A-1) after preliminary drying had a solid content of 95%. Onto the predried surface of (A-1), “RETAN PG2K” (product of KANSAI PAINT, acrylic-urethane organic solvent coating composition) was applied as a top coat to give a thickness of 30 μm, followed by forced drying at 60° C. for 30 minutes. The coated plate thus obtained was excellent in evenness and adhesion. In addition, drying did not cause any deformation of the coated plate.

### Example 2

A cationic electrodeposition coating (A-2) was applied to a zinc phosphate treated steel plate (20 cm long, 15 cm wide and 0.1 cm thick) by electrodeposition coating to give a thickness of 25 μm, followed by exposure to microwaves at an output power of 500 W for 1 minute for predrying. The wet coating of the cationic electrodeposition coating (A-2) after predrying had a solid content of 95%. A waterborne intermediate coating (B) was then applied to the predried surface of (A-2) to give a thickness of 30 μm, followed by exposure to microwaves at an output power of 500 W for 1 minute for predrying. The wet coating of the waterborne intermediate coating (B) after predrying had a solid content of 90%. By heating at 170° C. for 20 minutes and thereby causing crosslink, the wet coatings of the cationic electrodeposition coating (A-2) and waterborne intermediate coating (B) were simultaneously cured, whereby a coated plate (E-1) was obtained.

### Example 3

A light reflecting-pigment-containing thermosetting waterborne top coat (C-2) was applied to the coated plate (E-1) obtained in Example 2 to give a further thickness of 20 μm, followed by exposure to microwaves at an output power of 500 W for 2 minutes for predrying. The wet coating (C-2) of the thermosetting waterborne top coat after predrying had a solid content of 88%. Then, a thermosetting clear coating (D) was applied to the predried surface of the thermosetting waterborne top coat to give a thickness of 35 μm. By heating at 170° C. for 30 minutes, the wet coatings of the thermosetting waterborne top coat (C-2) and thermosetting clear coating (D) were cured simultaneously by crosslinking. The coated plate (F-1) thus obtained was excellent in evenness, finished appearance, adhesion and metallic color.

### Example 4

To the coated plate (E-1) obtained in Example 2, a coloring-pigment-containing thermosetting waterborne top coat (C-1) was applied to give a thickness of 30 μm, followed by exposure to microwaves at an output power of 500W for 1 minute for predrying. The wet coating of the thermosetting waterborne top coat (C-1) after predrying had a solid content of 90%. To the predried surface of the coloring-pigment-containing thermosetting waterborne top coat (C-1), a light reflecting-pigment-containing thermosetting waterborne top coat (C-2) was applied to give a thickness of 20 μm, followed by exposure to microwaves at an output power of 500W for 2 minutes for predrying. The wet coating of the thermosetting waterborne top coat (C-2) after preliminary drying had a solid content of 93%. Then, a thermosetting clear coating (D) was applied to the predried surface of the light reflecting-pigment-containing thermosetting aqueous top coat (C-2) to give a thickness of 35 μm. By heating at 170° C. for 30 minutes, these three layers of the coloring-pigment-containing thermosetting waterborne top coat (C-1), the light reflecting-pigment-containing thermosetting waterborne top coat (C-2) and thermosetting clear coating (D) were cured simultaneously by crosslinking. The coated plate (G-1) thus obtained was excellent in evenness, finished appearance, adhesion and metallic color.

### Comparative Example 1

In a similar manner to Example 1, the waterborne primer (A-1) was applied, followed by forced drying at 60° C. for 2 minutes instead of the predrying with microwaves. As a result, the wet coating of the waterborne primer coating (A-1) had a solid content of 40%. Moreover, as in Example 1, “RETAN PG2K” (product of KANSAI PAINT, acrylic urethane coating) was applied as a top coat to give a thickness of 30 μm, followed by forced drying at 60° C. for 30 minutes. The coated surface was markedly inferior in evenness because of insufficient drying of the waterborne primer.

### Comparative Example 2

In a similar manner to Example 1, the waterborne primer coating (A-1) was applied, followed by heating and drying at 90° C. for 5 minutes instead of predrying with microwaves. As a result, the solid content of the wet coating of the waterborne primer (A-1) was 94%. Moreover, as in Example 1, “RETAN PG2K” (product of KANSAI PAINT, acrylic urethane coating) was applied as a top coat to give a thickness of 30 μm, followed by forced drying at 60° C. for 30 minutes. The coated surface was dried sufficiently and no problem appeared in the evenness of the surface. The deformation of the coating plate however occurred.

### Comparative Example 3

In a similar manner to Example 1, the waterborne primer coating (A-1) was applied, followed by forced drying at 60° C. for 20 minutes instead of predrying with microwaves. As a result, the solid content of the wet coating of the waterborne primer (A-1) was 92%. Moreover, as in Example 1, “RETAN PG2K” (product of KANSAI PAINT, acrylic urethane coating) was applied as a top coat to give a thickness of 30 μm, followed by forced drying at 60° C. for 30 minutes. No problem appeared in the evenness of the surface, but the drying step was 18 minutes longer than that of Example 1.

### Comparative Example 4

In a similar manner to Example 1 except that a solventborne primer “SOFLEX 3200” (product of KANSAI PAINT, chlorinated polypropylene primer, adjusted to a solid content of 25%) was used instead of the waterborne primer (A-1), the primer was applied by spray to give a dry thickness of 7 μm, followed by predrying by exposure to microwaves at an output power of 300W for 2 minutes. As a result, the wet coating thus obtained had a solid content of 45%, suggesting that the predrying efficiency by microwaves was lower than that of Example 1 in which the waterborne primer was employed. Moreover, as in Example 1, “RETAN PG2K” was applied as a top coat to give a thickness of 30 μm, followed by forced drying at 60° C. for 30 minutes. Since the primer was not dried sufficiently, the coated surface was markedly inferior in evenness.

### Comparative Example 5

In a similar manner to Example 2 except that the predrying step with microwaves after application of the cationic electrodeposition coating (A-2) and waterborne intermediate coating (B) was changed to heating and drying, the coated plate (E-2) was obtained. In order to adjust the solid content of the wet coating of the cationic electrodeposition coating (A-2) to 95% in the predrying step by heating and drying after the application of the coating, heating and drying at 100° C. for 5 minutes was necessary. In order to simultaneously cure both the wet coatings of the cationic electrodeposition coating (A-2) and waterborne intermediate coating (B) after the application of the waterborne intermediate coating (B), heating and drying at 170° C. for 30 minutes without the predrying of the waterborne intermediate coating (B) was necessary. Compared with Example 2, the time spent for this example was 13 minutes longer than that in Example 2.

### Comparative Example 6

In a similar manner to Example 3 except that the predrying step with microwaves after the application of the thermosetting waterborne coating (C-2) was replaced by heating and drying, the coated plate (F-2) was obtained. In order to adjust the solid content of the wet coating of the thermosetting waterborne coating (C-2) to 88% in the predrying step by heating and drying after application of the coating, heating and drying at 100° C. for 10 minutes was necessary. The time spent in this Example was therefore 8 minutes longer than that in Example 3.

### Comparative Example 7

In a similar manner to Example 4 except that the predrying step with microwaves after application of the thermosetting waterborne coating (C-1) and thermosetting waterborne coating (C-2) was changed to heating and drying, the coating plate (G-2) was obtained. In order to adjust the solid content of the wet coating of the thermosetting waterborne coating (C-1) to 90% in the predrying step by heating and drying after the application of the thermosetting waterborne coating (C-1), heating and drying at 100° C. for 10 minutes was necessary. In order to adjust the solid content of the wet coating of a layer of the thermosetting waterborne coating (C-2) to 93% in the predrying step by heating and drying after the application of the thermosetting waterborne coating (C-2), heating and drying at 100° C. for 11 minutes was necessary. Compared with Example 4, the time spent in this Example was 18 minutes longer than that in Example 4.

What is claimed is:

1. A coating film forming method comprising applying a waterborne coating to a surface of a substrate and then drying to form a coating film, wherein a wet coating thereof is exposed to microwaves for predrying.

2. The coating film forming method according to claim 1, wherein the wet coating is exposed to microwaves at an output power of from 20W to 20 KW for from 10 seconds to 600 seconds.

3. The coating film forming method according to claim 1, wherein the solid content of the wet coating is controlled to 80% or greater by exposure to microwaves.

4. The coating film forming method according to claim 1, wherein the surface of the substrate is plastic.

5. The coating film forming method according to claim 4, wherein the plastic has a thermal softening point of 100° C. or less.

6. The coating film forming method according to claim 1, wherein the waterborne coating is a waterborne primer coating or electrodeposition coating; and after application of the waterborne primer coating or electrodeposition coating to the surface of the substrate, the wet coating is predried by exposure to microwaves, followed by application of a top coat.

7. The coating film forming method according to claim 1, wherein the waterborne coating is a waterborne primer coating or electrodeposition coating; and after application of the waterborne primer coating or electrodeposition coating to the surface of the substrate, the wet coating is predried by exposure to microwaves, followed by application of an intermediate coating.

8. The coating film forming method according to claim 1, wherein the waterborne coating is a waterborne primer coating or waterborne intermediate coating; and after application of the waterborne primer coating or waterborne intermediate coating to the surface of the substrate, the wet coating is predried by exposure to microwaves, followed by application of a top coat.

9. The coating film forming method according to claim 1, wherein the waterborne coating is a thermosetting waterborne top coat containing a coloring pigment and/or light reflecting pigment; and after application of the thermosetting waterborne top coat to the surface of the substrate, the wet coating is predried by exposure to microwaves, a thermosetting clear coating is applied, and then the both wet coatings are dried simultaneously by heating.

10. The coating film forming method according to claim 1, wherein the waterborne coating is a thermosetting waterborne top coat containing a coloring pigment an/or light reflecting pigment; and after application of a first thermosetting waterborne top coat containing the coloring pigment and/or light reflecting pigment to the surface of the substrate and predrying of the wet coating by exposure to microwaves, a second thermosetting waterborne top coat containing a coloring pigment and/or light reflecting pigment is applied, the wet coating is predried by exposure to microwaves, a thermosetting clear coating is applied, and the three wet coatings are then cured simultaneously by heating and drying.

11. The coating film forming method according to claim 1, wherein the waterborne coating comprises an elctrodeposition coating, waterborne intermediate coating and thermosetting waterborne top coat; and after application of the electrodeposition coating to the surface of the substrate and predrying of the wet coating by exposure to microwaves, the waterborne intermediate coating is applied, the wet coating is predried by exposure to microwaves, followed by heating and drying, the thermosetting waterborne top coat is applied, followed by predrying of the wet coating by exposure to microwaves, and a thermosetting clear coating is applied, followed by heating and drying.

12. The coating film forming method according to claim 1, wherein the waterborne coating comprises an electrodeposition coating, waterborne intermediate coating, a thermosetting waterborne top coat containing a coloring pigment, and a thermosetting waterborne top coat containing a light reflecting pigment; and after application of the electrodeposition coating to the surface of the substrate and predrying of the wet coating by exposure to microwaves, the waterborne intermediate coating is applied, the wet coating is predried by exposure to microwaves, followed by heating and drying, the thermosetting waterborne top coat containing a coloring pigment is applied, followed by predrying of the wet coating by exposure to microwaves, the thermosetting waterborne top coat containing a light reflecting pigment is applied, followed by predrying of the wet coating by exposure to microwaves, and a thermosetting clear coating is applied, followed by heating and drying.

13. A coated article obtained by a coating film forming method as claimed in claim 1.
